(19) United States
(12) Patent Application Publication
(10) Pub. No.: US 2013/0218585 A1
(43) Pub. Date: Aug. 22, 2013

(54) Health and Fitness Portal

(71) Applicant: ICON Health & Fitness, Inc., (US)

(72) Inventor: Mark Watterson, Logan, UT (US)

(73) Assignee: ICON Health & Fitness, Inc., Logan, UT (US)

(21) Appl. No.: 13/768,735

(22) Filed: Feb. 15, 2013

Related U.S. Application Data
(60) Provisional application No. 61/600,215, filed on Feb. 17, 2012.

(51) Int. Cl. G06F 19/00

(52) U.S. Cl. CPC G06F 19/322
USPC 705/2

(57) ABSTRACT

A method for presenting analytical data includes the steps of a computer system receiving data for a user, the data including a plurality of data portions that are each associated with a corresponding provider of a plurality of providers. Each data portion includes one or both of: health of the user or fitness of the user. The computer system aggregates the plurality of data portions to form aggregate data. The computer system receives a request from the user for analysis of the aggregate data by an analysis package of a first provider of the plurality of providers. The computer system shares the aggregate data with the first provider, including sharing aggregate data that is based on a data portion that corresponds with a second provider of the plurality of providers, and the computer system presenting analytical data to the user.

### CROSS-REFERENCE TO RELATED APPLICATIONS

This application claims priority to U.S. Provisional Patent Application No. 61/593,294 filed Jan. 31, 2012.

### TECHNICAL FIELD

This disclosure relates generally to systems, methods, and computer program products for health and exercise. More particularly, the disclosure relates to a health and fitness portal that aggregates health and/or fitness information from multiple providers and that enables providers to present custom views of the aggregate information.

### BACKGROUND

Exercise devices are being used at an ever increasing rate. Individuals use exercise devices to improve their health and fitness level. Recently, individuals have increasingly used electronic devices to record their workouts and to provide feedback during their workouts. For example, many providers produce dedicated portable exercise devices, such as cycling computers, running computers, heart rate monitors, pedometers, etc. Some portable exercise devices can generate a broad array of data, such as heart rate, speed, location, power generation, caloric use, etc. In addition, some gym equipment (e.g., treadmills, elliptical trainers) provide the ability for users to maintain a workout profile, and to take that profile with them (e.g., on a USB flash drive or through the Internet). Furthermore, individuals are now able to use more general-purpose devices, such as mobile telephones, personal media devices, or GPS units to record their workouts. For example, individuals may install applications on customizable mobile telephones (e.g., “smartphones”) that record exercise information (e.g., exercise type, time, duration), and that can make use of additional hardware devices, such as integrated or external GPS units, heart rate straps, pedometers, etc. to gather rich exercise data that may include biometric, location, and speed/distance information.

Many exercise devices and applications provide user interfaces for viewing exercise data during and/or after a workout. In addition, many exercise devices manufactures and application authors also provide individuals the ability to download exercise data from their devices and/or the ability to import the exercise data into exercise applications and/or websites. As such, users are able to view and track their exercise data over a period of time.

Beyond exercise, individuals increasingly track their diets and their general metabolic parameters (e.g., calories burned, heart rate, blood pressure, etc). They may do so through manual entry of relevant data (e.g., foods eaten and/or measured metabolic parameters) at a website or application, and/or with the use of electronic devices that track some of these parameters (e.g., pedometers, heart rate monitors).

Many individuals may use a variety of applications and/or web sites, in combination with a variety of devices, to track their exercise data. As such, these individuals can generate a great deal of health and fitness data spread across a variety of websites and/or applications. Each website and/or application may analyze a different dataset, and may provide a different view of the data.

### SUMMARY OF THE INVENTION

In one aspect of the disclosure, a method for presenting analytical data includes receiving data for a user, the data including a plurality of data portions that are each associated with a corresponding provider of a plurality of providers, each data portion concerning one or both of: health of the user or fitness of the user.

In another aspect that may be combined with any of the aspects herein, a method for presenting analytical data includes aggregating a plurality of data portions to form aggregate data.

In another aspect that may be combined with any of the aspects herein, a method for presenting analytical data includes receiving a request from a user, the request requesting analysis of aggregate data by an analysis package of a first provider of a plurality of providers.

In another aspect that may be combined with any of the aspects herein, a method for presenting analytical data includes sharing aggregate data with a first provider, including sharing aggregate data that is based on a data portion that corresponds with a second provider of a plurality of providers.

In another aspect that may be combined with any of the aspects herein, a method for presenting analytical data includes presenting analytical data to a user, the analytical data having been produced by an analysis package of a first provider based on aggregate data.

In another aspect that may be combined with any of the aspects herein, one or more of a plurality of data portions are received from one or more corresponding providers of a plurality of providers directly.

In another aspect that may be combined with any of the aspects herein, one or more of a plurality of data portions are received from one or more devices associated with one or more corresponding providers of a plurality of providers.

In another aspect that may be combined with any of the aspects herein, one or more of a plurality of data portions are received from one or more applications associated with one or more corresponding providers of a plurality of providers.

In another aspect that may be combined with any of the aspects herein, each provider of a plurality of providers provides one or more analysis packages, each analysis package being configured to generate analytical data from aggregated data.

In another aspect that may be combined with any of the aspects herein, a method for presenting analytical data includes providing a user interface that enables a user to select one or more analysis packages.

In another aspect that may be combined with any of the aspects herein, a method for presenting analytical data includes sharing at least a portion of aggregate data with an insurance company.

In another aspect that may be combined with any of the aspects herein, presenting analytical data to a user comprises presenting a health and fitness portal to the user.

In another aspect that may be combined with any of the aspects herein, a method for presenting analytical data includes providing a single sign-on, such that when a user provides credentials to any of a plurality of providers, the user arrives at a health and fitness portal.

In another aspect that may be combined with any of the aspects herein, data concerning health of a user includes data concerning one or more of: food consumption by the user, caloric burn data for the user, or heart rate data for the user.

In another aspect that may be combined with any of the aspects herein, data concerning fitness of a user includes data concerning one or more exercises performed by the user.

In another aspect that may be combined with any of the aspects herein, a method for presenting analytical data includes associating each of a plurality of data portions with a corresponding token, each corresponding token identifying one or both of: an identity of a corresponding provider or an identity of a user.

In another aspect that may be combined with any of the aspects herein, a method for presenting analytical data includes enforcing a security policy for aggregate data.

In another aspect that may be combined with any of the aspects herein, enforcing a security policy includes preventing at least one provider of a plurality of providers from obtaining a data portion associated with a different provider of the plurality of providers.

In another aspect that may be combined with any of the aspects herein, enforcing a security policy includes preventing the sharing of the aggregate data with a provider for which a user has no associated device.

In another aspect that may be combined with any of the aspects herein, aggregating a plurality of data portions to form aggregate data comprises aggregating results included in a plurality of data portions, the results selected from among: total calories consumed, total calories burned during a workout, total distance covered during a workout, total time to accomplish a workout, average speed during a workout, average heart rate during a workout, or total power generated during a workout.

In another aspect that may be combined with any of the aspects herein, a method for aggregating data includes receiving data for a user, the data including a first data portion that is associated with a first provider and a second data portion that is associated with a second provider, the first and second data portions concerning one or both of: health of the user or fitness of the user.

In another aspect that may be combined with any of the aspects herein, a method for aggregating data includes identifying summary data for each of first and second data portions related to first and second providers, the summary data relating to one or more of: one or more health metrics for a user or one or more fitness metrics for the user, including identifying first summary data for the first portion of data that is compatible with second summary data for the second portion of data.

In another aspect that may be combined with any of the aspects herein, a method for aggregating data includes aggregating first summary data for a first provider and second summary data for a second provider to form aggregate data.

In another aspect that may be combined with any of the aspects herein, a method for aggregating data includes sharing aggregate data with a first provider for analysis by the first provider, including sharing aggregate data that is based on second summary data for a second provider.

In another aspect that may be combined with any of the aspects herein, aggregating first summary data for a first provider and second summary data for a second provider to form aggregate data comprises tracking the contribution of the first provider and the second provider to the aggregate data.

In another aspect that may be combined with any of the aspects herein, a first data portion that is associated with a first provider includes a first type of summary data and a second data portion that is associated with a second provider includes both the first type of summary data and a second additional type of summary data not included in the first data portion, and wherein sharing aggregate data with an analysis package that is provided by the first provider includes sharing the second type of summary data.

In another aspect that may be combined with any of the aspects herein, receiving data for a user comprises receiving the data from one or more of: the user, first and second providers, or one or more devices associated with one or both of the first and second providers.

In another aspect that may be combined with any of the aspects herein, a computer system includes one or more processors, system memory, and one or more computer storage media having stored thereon computer-executable instructions which, when executed by the one or more processors, cause the computer system to implement a method for presenting analytical data.

In another aspect that may be combined with any of the aspects herein, computer-executable instructions which, when executed the one or more processors, implement a method for presenting analytical data include computer-executable instructions which, when executed, cause a computer system to receive data for a user, the data including a plurality of data portions that are each associated with a corresponding provider of a plurality of providers, each data portion concerning one or both of: health of the user or fitness of the user.

In another aspect that may be combined with any of the aspects herein, computer-executable instructions which, when executed the one or more processors, implement a method for presenting analytical data include computer-executable instructions which, when executed, cause a computer system to aggregate a plurality of data portions to form aggregate data.

In another aspect that may be combined with any of the aspects herein, computer-executable instructions which, when executed the one or more processors, implement a method for presenting analytical data include computer-executable instructions which, when executed, cause a computer system to receive a request from a user, the request requesting analysis of aggregate data by an analysis package of a first provider of a plurality of providers

In another aspect that may be combined with any of the aspects herein, computer-executable instructions which, when executed the one or more processors, implement a method for presenting analytical data include computer-executable instructions which, when executed, cause a computer system to share aggregate data with a first provider, including sharing aggregate data that is based on a data portion that corresponds with a second provider of a plurality of providers.

In another aspect that may be combined with any of the aspects herein, computer-executable instructions which, when executed the one or more processors, implement a method for presenting analytical data include computer-executable instructions which, when executed, cause a computer system to present analytical data to a user, the analytical data having been produced by an analysis package of a first provider based on aggregate data.

### BRIEF DESCRIPTION OF THE DRAWINGS

FIG. 1 illustrates a computer architecture of a health and fitness portal according to one example embodiment of the present disclosure.

FIG. 2 illustrates a flowchart of an example method for presenting analytical data according to one example embodiment of the present disclosure.

FIG. 3 illustrates a flowchart of an example method for aggregating data according to one example embodiment of the present disclosure.

FIG. 4 illustrates an example user interface of a health and fitness portal according to one example embodiment of the present disclosure.

FIG. 5A illustrates an additional example user interface of a health and fitness portal according to one example embodiment of the present disclosure.

FIG. 5B illustrates an example “app store” user interface of a health and fitness portal according to one example embodiment of the present disclosure.

### DETAILED DESCRIPTION

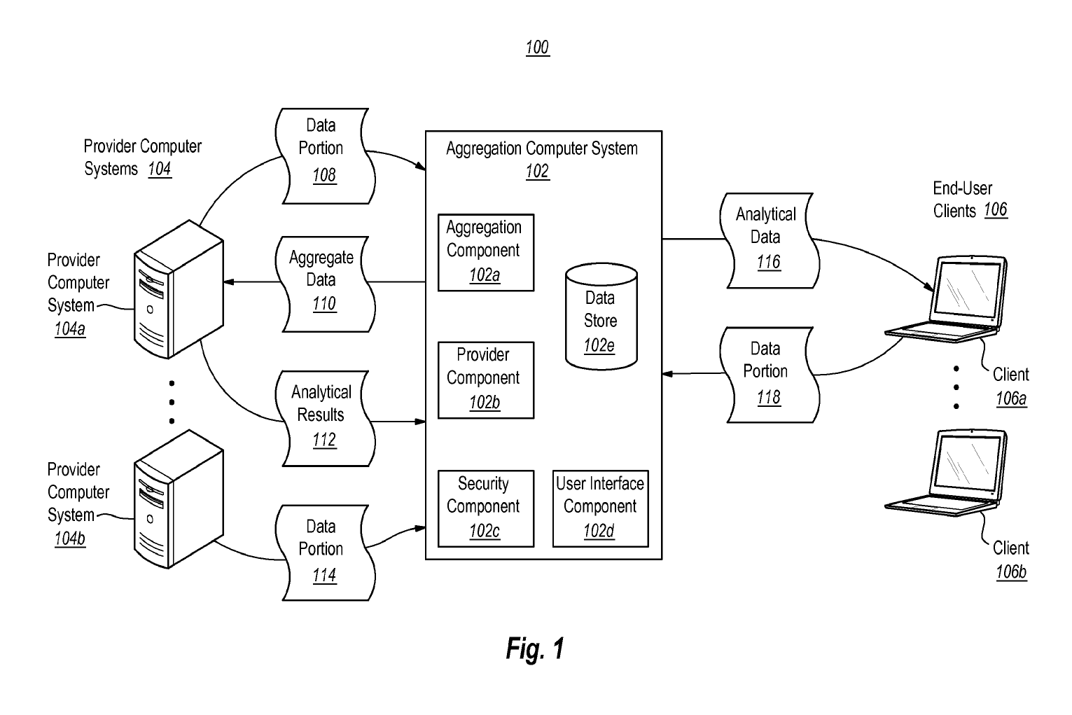

This disclosure relates generally to systems, methods, and computer program products for health and exercise. Depicted in FIG. 1 is a computer architecture 100 of a health and fitness portal, which may incorporate novel functionalities, software modules, and the like. As depicted, computer architecture 100 includes aggregation computer system 102, provider computer systems 104 and end-user clients 106. Each of the depicted computer systems is connected to one another over (or is part of) a network, such as, for example, a Local Area Network (“LAN”), a Wide Area Network (“WAN”), and even the Internet. Accordingly, each of the depicted computer systems as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Aggregation computer system 102 is configured to provide a health and/or fitness portal (referred to herein as a “portal” for simplicity). The portal aggregates health and/or fitness data for users at end-user clients 106 and provides analytical views of the aggregated data based on analysis performed by provider computer systems 104. In one embodiment, aggregation computer system 102 provides a web-based portal to end-user clients 106. In this embodiment, the web-based portal enables users to add analysis “apps” from provider computer systems 104. These “apps” analyze health and/or fitness data for the users and present resulting analytics to the users. It will be appreciated that aggregation computer system 102 may comprise a single computer system, or may be distributed across a plurality of computer systems.

Provider computer systems 104 comprise computer systems corresponding to a plurality of health and/or fitness providers. For example, provider computer systems 104 may correspond to entities who provide fitness devices or applications (e.g., portable fitness computers, fitness applications for mobile devices), providers who provide health or fitness services (e.g., calorie and diet tracking, workout scheduling and/or tracking, gyms and/or clubs), healthcare providers, insurance companies). As indicated by the vertical ellipses, provider computer systems 104 can include any number of computer systems. As depicted, for example, provider computer systems 104 can include provider computer system 104a and provider computer system 104b.

End-user clients 106 comprise computer systems that are used by end-users of the portal. End-user clients 106 can include any number of clients (i.e., one or more clients), and can comprise clients of varying types. For example, end-user clients 106 may comprise any combination of desktop computers, laptop computers, tablet computers, mobile telephone devices, mobile media devices, and the like. In the depicted example, end-user clients 106 include client 106a and client 106b.

As depicted, aggregation computer system 102 can include aggregation component 102a, provider component 102b, security component 102c, user interface component 102d, and data store 102e. Aggregation component 102a is configured to aggregate different portions of health and/or fitness data received by aggregation computer system 102. In some embodiments, aggregation component 102a is configured to identify like or similar data types in different portions of health and/or fitness data, and to aggregate the like or similar data. For example, aggregation component 102a may identify summary data (e.g., total workout time, total distance moved, average heart rate, calories consumed, calories burned, power generated) from disparate data portions, and aggregate the summary data. In additional or alternative embodiments, aggregation component 102a is configured to aggregate data of different types. For example, aggregation component 102a may combine differing data types from various data portions in any appropriate matter, such as in a manner which reflects a number of workouts, total calories consumed, and total calories burned each week.

Aggregation computer system 102 can be configured to receive health and/or fitness data from a variety of sources, such as from provider computer systems 104, from end-user clients 106, or from any other appropriate entity. For example, FIG. 1 depicts aggregation computer system 102 receiving data portion 108 and data portion 114 from provider computer systems 104a and 104b, respectively. FIG. 1 also depicts aggregation computer system 102 receiving data portion 118 from end-user client 106a. Data portions may be generated by users and/or by devices. For example, data portions generated by users may comprise health and/or fitness data entered by a user at provider computer systems 104 and/or at aggregation computer system 102. Data portions generated by devices may comprise health and/or fitness data generated by a portable fitness device (e.g., a cycle computer, a heart rate monitor, a calorie monitor) or by an application (e.g., an application on a mobile device). Data portions generated by devices by be obtained from end-user clients 106 (e.g., in connection with a user uploading data from his device) or from provider computer systems (e.g., data generated by an application on a mobile device).

Provider component 102b is configured to manage which provider computer systems 104 aggregation computer system 102 is configured to operate with. Provider component 102b is also configured to manage analysis package(s) that each provider computer system 104 provides to aggregation computer system 102. In general, analysis packages provided by provider computer systems 104 are configured to analyze health and/or fitness data (e.g., aggregate health and/or fitness data received from aggregation computer system 102) and to generate analytical results from the data. For example, FIG. 1 depicts that provider computer system 104a receives aggregate data 110 from aggregation computer system 102 and provides analytical results 112 to aggregation computer system 102. Analysis packages may generate any appropriate analytical results, such as results that include charts or maps, results that compare different types of data, results that compare fitness or health-related results to a plan or goal, results that make recommendations based on the data, and so on.

Security component 102c is configured to manage which aggregate data can be provided to which provider computer system. For example, some aggregate results may be available to one provider computer system but not to another provider computer system. This may be due to licensing or other agreements between aggregation computer system 102 and provider computer systems 104, due to licensing or other agreements among provider computer systems 104, and/or due to licensing or other agreements between an end user and provider computer systems 104 and/or aggregation computer system 102. For example, it may be that provider computer system 104a is not allowed to receive aggregate data 110 that includes aggregate information based data associated with provider computer system 104b (e.g., data portion 114 and/or data portion 118, which may include data generated by a device associated with provider computer system 104b). As such, security component 102c can enforce this restriction.

Security component 102c can also be configured to manage which analysis package(s) a particular end-user has access to. For example, it may be that an end user only has access to analysis packages of a particular provider computer system if that user owns a device associated with the particular provider, or if the user has an account with the particular provider.

User interface component 102d is configured to present a portal to end-user clients 106. In some embodiments, user interface component 102d may present a web-based interface to end-user clients 106. In other embodiments, user interface component 102d may present appropriate data for driving an application running at end-user clients 106. In some embodiments, user interface component 102d is configured to display analytical data provided by analysis packages. For example, FIG. 1 depicts that aggregation computer system 102 presents analytical data 116 to client 106a. Analytical results are generally configured to be displayed at a user interface. As such, analytical packages may generate structural data (e.g., XML) that can be interpreted by user interface component 102d, or may generate markup that can be directly rendered (e.g., HTML) and which can be incorporated into an interface generated by user interface component 102d. In some embodiments, analysis packages generate analytical data/results according to an API defined by aggregation computer system 102.

Data store 102e is configured to store aggregate data. Data store 102e can comprise any appropriate data storage mechanism, such as a flat-file, a relational database, etc. Data store 102e may exist at aggregation computer system 102, or may be located remotely. In some embodiments, aggregation computer system 102 stores only aggregate data in data store 102e, while in other embodiments aggregation computer system 102 stores both aggregate data and the original data portions. When storing aggregate data and/or various source portions of health and/or fitness data, aggregation computer system 102 may tag the data. For example, aggregation computer system 102 may attach a token that identifies a user to whom the data is associated, a provider computer system 104 to which the data is associated, etc. When storing aggregate data, aggregation computer system 102 may tag the aggregate data with a token identifying the data portions and/or associated providers that contribute to the aggregate data. Data store 102e can store any other type of data related to operation of aggregation computer system 102, such as user profile data, data about provider computer systems 104, security profile data, etc.

In some embodiments, aggregation computer system 102 provides single sign-on functionality. For example, when an end-user logs-in at one of provider computer systems 104, the user may arrive at the portal provided by aggregation computer system 102. This may be accomplished through redirection (i.e., provider computer systems 104 may be configured to redirect the user to aggregation computer system 102). In some embodiments, aggregation computer system 102 provides shared credentials which are usable by provider computer systems 104 in authenticating users.

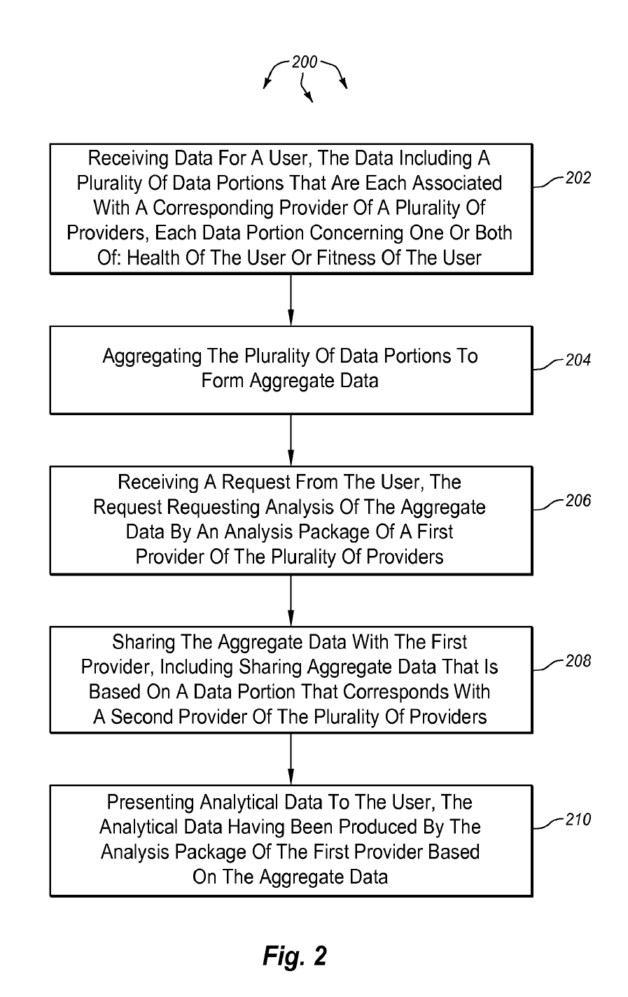

Embodiments of the present disclosure may be described in the context of acts in computer-implemented methods. FIG. 2, for example, illustrates a flow chart of an example method 200 for presenting analytical data. Method 200 will be described with respect to the components and data of computer architecture 100.

Method 200 includes an act of receiving data for a user, the data including a plurality of data portions that are each associated with a corresponding provider of a plurality of providers, each data portion concerning one or both of: health of the user or fitness of the user (act 202). For example, aggregation computer system 102 can receive data portions concerning the health and/or fitness of a user at client 106a. These data portions may include data portion 108, data portion 114 and/or data portion 118. The data portions can be associated with provider computer systems 104a and 104b, such as by originating from the provider itself, by originating from a device produced by the provider, by originating from an application produced from the provider, etc.

Method 200 also includes an act of aggregating the plurality of data portions to form aggregate data (act 204). For example, aggregation component 102a can aggregate data contained in any received data portions. Aggregation can include identifying data of similar types across the data portions and combining this data. Aggregation can also include combining data of differing types to produce a broader snapshot of the health and/or fitness of the user.

Method 200 also includes an act of receiving a request from the user, the request requesting analysis of the aggregate data by an analysis package of a first provider of the plurality of providers (act 206). For example, a user at client 106a can request that an analysis package at provider computer system 104a provide analytical results of aggregate data in data store 102e.

Method 200 also includes an act of sharing the aggregate data with the first provider, including sharing aggregate data that is based on a data portion that corresponds with a second provider of the plurality of providers (act 208). For example, aggregation computer system 102 can send aggregate data 110 to provider computer system 104a for analysis. Aggregate data 110 can include some data based on data associated with provider computer system 104b (e.g., data from data portion 114). In response, aggregation computer system 102 can receive analytical results 112 from provider computer system 104a.

Method 200 also includes an act of presenting analytical data to the user, the analytical data having been produced by the analysis package of the first provider based on the aggregate data (act 210). For example, user interface component 102d can produce a user interface for client 106a that includes analytical data 116. In the context of a web portal, for example, a web page may include markup generated by provider computer system 104a that is included in analytical results 112.

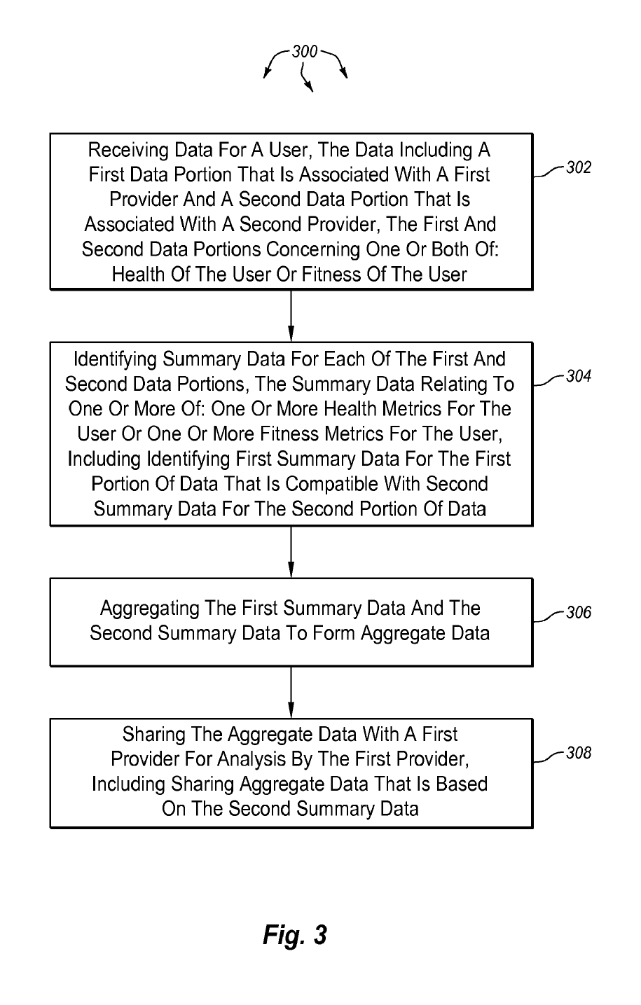

FIG. 3 illustrates a flow chart of an example method 300 for aggregating data. Method 300 will be described with respect to the components and data of computer architecture 100.

Method 300 includes an act of receiving data for a user, the data including a first data portion that is associated with a first provider and a second data portion that is associated with a second provider, the first and second data portions concerning one or both of: health of the user or fitness of the user (act 302). For example, aggregation computer system 102 can receive data portion 108, data portion 114 and/or data portion 118, which each concern the health or fitness of a user at client 106a. For example, data portion 108 may be associated with provider computer system 104a, data portion 114 may be associated with provider computer system 104b, and data portion 118 may be associated with either provider computer system, such as by originating from an associated device or application.

Method 300 also includes an act of identifying summary data for each of the first and second data portions, the summary data relating to one or more of: one or more health metrics for the user or one or more fitness metrics for the user, including identifying first summary data for the first portion of data that is compatible with second summary data for the second portion of data (act 304). For example, aggregation component 102a can identify data of the same or similar types (e.g., total workout time, calories burned, calories consumed, etc.) across different data portions and aggregate that information. For example, data portion 108 may contain workout information recorded by an application associated with provider computer system 104a, including total workout time, calories burned, etc. Data portion 118 may contain workout information recorded by a device associated with provider computer system 104b, including total workout time, calories burned, etc.

Method 300 also includes an act of aggregating the first summary data and the second summary data to form aggregate data (act 306). For example, aggregation component 102a can aggregate information identified from data portion 108 and data portion 118, and store the aggregate data in data store 102e.

Method 300 also includes an act of sharing the aggregate data with a first provider for analysis by the first provider, including sharing aggregate data that is based on the second summary data (act 308). For example, aggregation computer system 102 can share aggregate data 110 with provider computer system 104a. Aggregate data 110 can include data from data portion 108 (associated with provider computer system 104a) and data portion 118 (associated with provider computer system 104b).

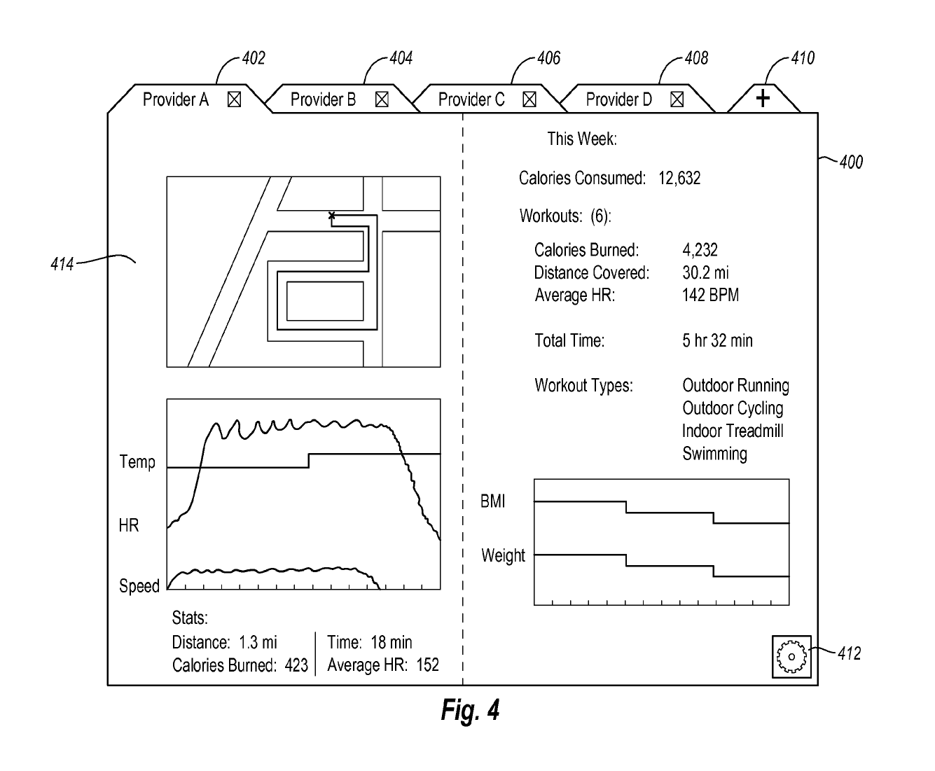

Embodiments of the invention can also be described in the context of user interfaces. Such user interfaces may be generated by user interface component 102d, and may include content generated by one or more provider computer systems 104. FIG. 4, for example, illustrates an example user interface 400 of a health and fitness portal. User interface 400 can include a plurality of tabs, each tab corresponding to a different provider and/or to different analytical packages of providers. As depicted, for example, user interface 400 may include tabs 402, 404, 406 and 408 corresponding to providers A, B, C, and D, respectively. For example, provider A may be a fitness device manufacturer (e.g., a cycle computer, a heart rate monitor), provider B may be a diet company, provider C may be an indoor fitness company (e.g., a gym), and provider D may be an author of a fitness application for mobile devices.

User interface 400 can include any appropriate mechanism for managing providers, such as add tab 410 and close buttons that appear on each tab. When selecting add tab 410, a user may be presented with an “app store” (not shown) for adding new providers or analytical packages. In addition, user interface 400 can include any appropriate mechanism for managing settings for providers and/or for a user profile, such as configure button 412.

As depicted, tab 402 is active and content 414 of tab 402 shows analytical results generated by provider A. The displayed analytical results can include results based on data associated with provider A. For example, content 414 can include details of a most recent workout recorded by provider A, such as a run that was recorded by a device manufactured by provider A. In addition, the displayed analytical results can include results based on aggregate data, including data from other providers. For example, content 414 can include a summary of eating and workouts over a period of time (e.g., a week). For example, content 414 can include caloric intake data and weight data entered at a website of provider B (a diet company), as well as summary data derived from data recorded by providers A, C, and D (e.g., outdoor running workout(s) recorded by a device of provider A, outdoor cycling workout(s) recorded by a device of provider B, indoor treadmill workout(s) recorded by a treadmill of provider C, and swimming workout(s) entered into an application of provider D.

It will be appreciated that the content and format of analytical results from each provider or analytical package can differ depending on preferences of the user and design choices of the providers. For example, provider B may choose to provide more detail about eating and less detail about workouts. In addition, depending on agreements among providers, the health and fitness portal and/or the user, some providers may have access to different aggregate data than other providers, further affecting the analytical results displayed.

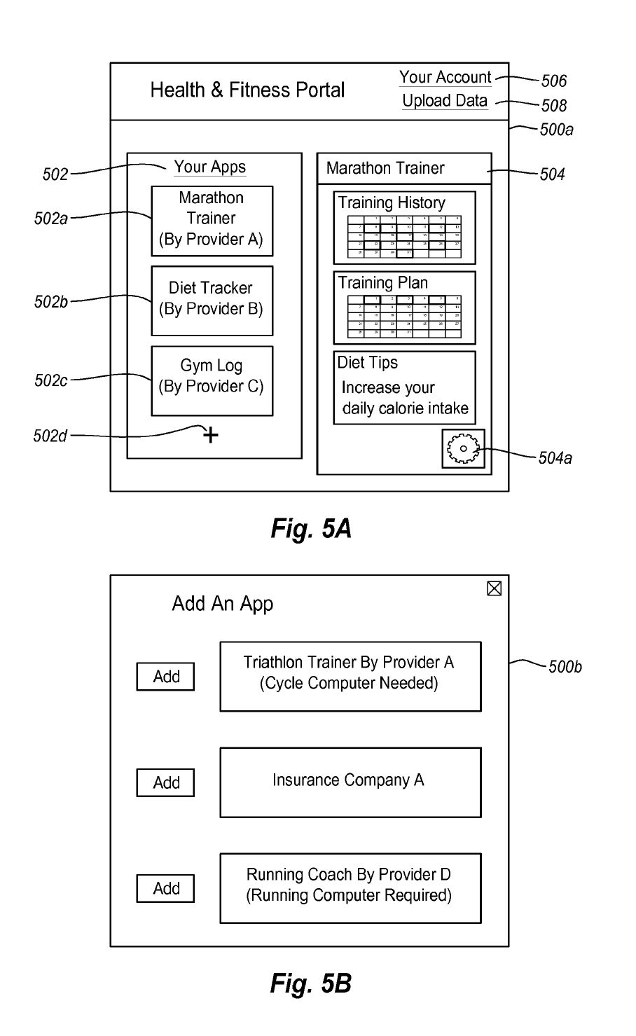

FIG. 5A illustrates an additional example user interface 500a of a health and fitness portal. As depicted user interface 500a can include an app selection portion 502 which provides buttons for selecting a configured analytical package. For example, based on a user configuration, app selection portion 502 may include button 502a for a marathon trainer analytical package by provider A, button 502b for a diet tracker analytical package by provider B, and button 502c for a gym log analytical package by provider C.

Upon selection of a button, user interface 500a can display analytical results of the selected analytical package in content portion 504. As depicted, for example, content portion 504 presents analytical results of the marathon trainer analytical package by provider A. In some embodiments, content portion 504 is populated by markup (e.g., HTML) generated by the analytical package. Content portion 504 includes analytical results that aggregate health and/or fitness data from multiple providers. For example, content portion 504 shows a marathon training history, a marathon training plan, and diet tips. These results may be generated based on outdoor running workouts recorded by provider A, food consumption recorded by provider B, and indoor running workouts recorded by provider C.

Content portion 504 can also include configure button 504a. Configure button 504a can be selected to configure the information displayed by a particular analytical package. For example, a user may be able to select the format in which the particular analytical package presents data, different types of data that the analytical package presents, providers upon which the analytical results can be based, or any other appropriate configuration options.

User interface 500a can also include additional configuration options as appropriate. For example, account link 506 may be selected to edit a user profile, such as age, gender, body type, workout preferences, training goals, weight loss goals, etc. Account link 506 may also be used to associate new devices with a user. In addition, user interface 500a may include an upload data link 508, which may be selected to upload new health and/or fitness data, such as data from a fitness device or application.

FIG. 5B illustrates an example “app store” user interface 500b of a health and fitness portal. User interface 500b may appear upon selection of an appropriate option in user interface 500a, such as add button 502d. User interface 500b presents analytical packages that can be configured for use by a user. In some embodiments, user interface 500b is customized based on a profile or history of a user. For example, if a user has indicated that she is interested in cycling, user interface 500b may present cycling-related analytical packages. User interface 500b may present a plurality of analytical packages, potentially with a description, along with a mechanism for adding one or more packages to app selection portion 502. Some analytical packages may require purchase of a hardware device, an application, and/or a subscription, and these requirements may be communicated by user interface 500b. As depicted, a single provider may provide a plurality of analytical packages. For example, provider A is depicted in FIG. 5A as providing a “marathon trainer” analytical package; in addition, provider A is depicted in FIG. 5B as providing a “triathlon trainer” analytical package.

In some embodiments, analytical packages may be used to share health and/or fitness data with insurance companies. For example, an insurance company may use an analytical package to gather aggregate health and/or fitness data. Based on the aggregate data gathered by the insurance company, the insurance company may provide a discounted insurance premium, may make health assessments, may provide health recommendations, etc. Similarly, an analytical package from a doctor or hospital may provide healthcare personnel with health and/or fitness data which can be used to make healthcare decisions.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The present disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

### INDUSTRIAL APPLICABILITY

In general, the embodiments of the present disclosure relate to exercise systems, methods, and computer program products that enable health and fitness providers to analyze aggregate data, including data from other health and fitness providers, and to provide results of the analysis to users. Thus, the systems, methods, and computer program products of the present disclosure enable each health and fitness provider to leverage a greater variety of health and/or fitness data during analysis than would otherwise be available.

By bringing together health and fitness data that would conventionally be analyzed separately, the systems, methods, and computer program products of the present disclosure enable individuals to gain a more complete picture of their health and fitness than would conventionally be possible. Using conventional mechanisms, for example, data from a fitness computer would be analyzed by the manufacture of the fitness computer, data from a fitness application would be analyzed by a provider of the fitness application, dietary data would be analyzed by provider of dietary analysis, and so on. Thus, users would conventionally get a limited analysis of their health and fitness from each provider, since the users' health and fitness data is divided amongst a plurality of distinct “silos.” By contrast, the systems, methods, and computer program products of the present disclosure enable users to get a more complete analysis of their health and fitness by aggregating data from multiple providers. In addition, the systems, methods, and computer program products of the present disclosure enable users to obtain that analysis in a manner preferable to the users. For example, a user can use an analysis package of a provider that presents data in a manner preferred by the user, as opposed to being limited to a format dictated by a single provider.

The systems, methods, and computer program products of the present disclosure also benefit users by encouraging competition among health and fitness providers, while at the same time encouraging cooperation between the health and fitness providers. Competition is encouraged because providers are incentivized to produce better data analytics to compete with analytics of other providers. Competition is also encouraged because providers are incentivized to produce better end-user products. For example, users have conventionally been encouraged to be locked into an application or device “ecosystem” of a single provider so that users can position more data at the provider and in turn make better use of the analytics of the provider. As such, it may be difficult for users to choose a superior product from a competing provider. However, by providing device and/or application data to other providers, the effect of vendor “lock-in” is mitigated against.

Cooperation is encouraged because each provider can provide better analytics as more data is made available from other providers. As such, it may be in the interest of each provider to cooperate in the information exchange enabled by the systems, methods, and computer program products of the present disclosure.

What is claimed is:

1. A method, implemented at a computer system that includes one or more processors, for presenting analytical data, comprising acts of:
the computer system receiving data for a user, the data including a plurality of data portions that are each associated with a corresponding provider of a plurality of providers, each data portion concerning one or both of: health of the user or fitness of the user;
the computer system aggregating the plurality of data portions to form aggregate data;
the computer system receiving a request from the user, the request requesting analysis of the aggregate data by an analysis package of a first provider of the plurality of providers;
the computer system sharing the aggregate data with the first provider, including sharing aggregate data that is based on a data portion that corresponds with a second provider of the plurality of providers; and
the computer system presenting analytical data to the user, the analytical data having been produced by the analysis package of the first provider based on the aggregate data.

2. The method as recited in claim 1, wherein one or more of the plurality of data portions are received from one or more corresponding providers of the plurality of providers directly.

3. The method as recited in claim 1, wherein one or more of the plurality of data portions are received from one or more devices associated with one or more corresponding providers of the plurality of providers.

4. The method as recited in claim 1, wherein one or more of the plurality of data portions are received from one or more applications associated with one or more corresponding providers of the plurality of providers.

5. The method as recited in claim 1, wherein each provider of the plurality of providers provides one or more analysis packages, each analysis package being configured to generate analytical data from the aggregated data.

6. The method as recited in claim 5, further comprising an act of:
the computer system providing a user interface that enables the user to select one or more of the analysis packages.

7. The method as recited in claim 1, further comprising an act of:
the computer system sharing at least a portion of the aggregate data with an insurance company.

8. The method as recited in claim 1, wherein presenting the analytical data to the user comprises presenting a health and fitness portal to the user, the method further comprising an act of:
the computer system providing a single sign-on, such that when the user provides credentials to any of the plurality of providers, the user arrives at the health and fitness portal.

9. The method as recited in claim 1, wherein data concerning health of the user includes data concerning one or more of: food consumption by the user, caloric burn data for the user, or heart rate data for the user.

10. The method as recited in claim 1, wherein data concerning fitness of the user includes data concerning one or more exercises performed by the user.

11. The method as recited in claim 1, further comprising an act of:
the computer system associating each of the plurality of data portions with a corresponding token, each corresponding token identifying one or both of: an identity of the corresponding provider or an identity of the user.

12. The method as recited in claim 1, further comprising an act of:
the computer system enforcing a security policy for the aggregate data.

13. The method as recited in claim 12, wherein enforcing the security policy includes preventing at least one provider of the plurality of providers from obtaining a data portion associated with a different provider of the plurality of providers.

14. The method as recited in claim 1, wherein enforcing the security policy includes preventing the sharing of the aggregate data with a provider for which the user has no associated device.

15. The method as recited in claim 1, wherein aggregating the plurality of data portions to form aggregate data comprises aggregating results included in the plurality of data portions, the results selected from among: total calories consumed, total calories burned during a workout, total distance covered during a workout, total time to accomplish a workout, average speed during a workout, average heart rate during a workout, or total power generated during a workout.

16. A method, implemented at a computer system that includes one or more processors, for aggregating data, comprising acts of:
the computer system receiving data for a user, the data including a first data portion that is associated with a first provider and a second data portion that is associated with a second provider, the first and second data portions concerning one or both of: health of the user or fitness of the user;
the computer system identifying summary data for each of the first and second data portions, the summary data relating to one or more of: one or more health metrics for the user or one or more fitness metrics for the user, including identifying first summary data for the first portion of data that is compatible with second summary data for the second portion of data;
the computer system aggregating the first summary data and the second summary data to form aggregate data; and
the computer system sharing the aggregate data with a first provider for analysis by the first provider, including sharing aggregate data that is based on the second summary data.

17. The method as recited in claim 16, wherein aggregating the first summary data and the second summary data to form aggregate data comprises tracking the contribution of the first provider and the second provider to the aggregate data.

18. The method as recited in claim 16, wherein the first data portion that is associated with a first provider includes a first type of summary data and the second data portion that is associated with a second provider includes both the first type of summary data and a second additional type of summary data not included in the first data portion, and wherein sharing the aggregate data with the analysis package that is provided by the first provider includes sharing the second type of summary data.

19. The method as recited in claim 16, wherein receiving data for the user comprises receiving the data from one or more of: the user, the first and second providers, or one or more devices associated with one or both of the first and second providers.

20. A computer system, comprising:
one or more processors;
system memory; and
one or more computer storage media having stored thereon computer-executable instructions which, when executed by the one or more processors, cause the computer system to implement a method for presenting analytical data, including:
receiving data for a user, the data including a plurality of data portions that are each associated with a corresponding provider of a plurality of providers, each data portion concerning one or both of: health of the user or fitness of the user;
aggregating the plurality of data portions to form aggregate data;
receiving a request from the user, the request requesting analysis of the aggregate data by an analysis package of a first provider of the plurality of providers;
sharing the aggregate data with the first provider, including sharing aggregate data that is based on a data portion that corresponds with a second provider of the plurality of providers; and
presenting analytical data to the user, the analytical data having been produced by the analysis package of the first provider based on the aggregate data.
